(19) United States
(12) Patent Application Publication
(10) Pub. No.: US 2016/0062331 A1
(43) Pub. Date: Mar. 3, 2016

(54) APPARATUS AND METHOD FOR VALIDATING THE INTEGRITY OF CONTROL SIGNALS IN TIMING DOMAIN

(71) Applicant: WILHARD CHRISTOPHORUS VON WENDORFF, Munich (DE)

(72) Inventor: WILHARD CHRISTOPHORUS VON WENDORFF, Munich (DE)

(73) Assignee: FREESCALE SEMICONDUCTOR, INC., Austin, TX (US)

(21) Appl. No.: 14/469,740

(22) Filed: Aug. 27, 2014

(51) Int. Cl. G05B 19/042

(52) U.S. Cl. CPC G05B 19/042; G05B 2219/24195

(57) ABSTRACT

The present application relates to a signal integrity module for validating one or more control signals in time domain and a method thereof. The one or more control signals are received via a signal input from at least one control signal generating unit. A new signature is generated by a signature generating unit on the basis of a current signature and the state of the one or more control signals at a watch point. The current signature is latched into a signature register upon receiving a trigger signal. The latched signature is representative of the time course of the one or more control signals at the watch point over a monitoring period defined by the trigger signal. The latched signature is compared by a signature comparator with a pre-calculated signature to validate the integrity of the one or more control signals with respect to the time domain.

### FIELD OF THE INVENTION

The field of this invention relates to signal timing integrity determination, for example for time domain signal generators.

### BACKGROUND OF THE INVENTION

Many circuits that generate signals in the time domain are periodic, for example the circuit generates a specific pulse width modulated (PWM) signal that is expected to exhibit a given duty cycle and period. Often, complex control of the generated timing signal requires use of trigger sequences, which are also often periodic in nature, for example a start analogue-to-digital conversion (ADC) operation, move data by ADC, trigger timer, etc. . . . ). Functional safety applications require techniques to detect, in real-time, integrity issues of safety-relevant circuits. In particular, it is often desired to detect and respond to signal integrity issues within time based signal generators, e.g. pulse width modulation circuits, cross-timing units, etc.

Often modern measurement instruments rely on powerful digital signal processing (DSP) techniques to facilitate automation and to enhance measurement accuracy and repeatability. Using DSP techniques, a device-under-test (DUT) response signal may be measured by first digitizing it using an accurate ADC. Subsequently, microprocessor-based computations may be performed in order to analyse the digitised signals. The digitisation step involves a clocking circuit, often called a ‘time-based generator’, in addition to the ADC. In general, the clocking circuit is the most important and most challenging component within time-based signal generators, in terms of design and implementation.

FIG. 1 illustrates a semiconductor device 100 comprising a processing system 105, as illustrated in US2011/0060954 A1. The processing system 105 comprises processor 110 arranged to execute program instructions, signature generator 120 arranged to receive a value from an internal memory location 130, and to generate a current signature value, based on the received value. Signature generator 120 is coupled to a signature register 140, and is arranged to store the most recently generated current signature value in the signature register 140. In this manner, the signature register 140 contains, and may make available, the most recently generated current signature value. Processing system 105 further comprises validation circuit 150 arranged to validate the current signature value generated by the signature generator 120, and to output an error indication based on the result of validating the current signature value. The processor 110 is further arranged, upon execution of a signature instruction, to enable the validation of the current signature value by the validation circuit 150.

The validation circuit 150 comprises a comparator 160 arranged to receive the current signature value generated by the signature generator 120, and compare the current signature value with a reference signature value, and to output an indication of whether the current signature value substantially matches the reference signature value. In particular, the comparator logic 160 is operably coupled to the signature register 140, and arranged to receive the most recent current signature value stored therein. The validation circuit 150 comprises an indicator circuit 170, operably coupled to the comparator 160. The indicator circuit 170 is further operably coupled to the processor 110 and arranged, upon receipt of an enabling signal from the processor 110, to output a validation indication based on the indication output by the comparator 160. Validation circuit 150 enables the current signature value to be validated, without the need for the validation to be performed at the processor 110.

The circuit of FIG. 1 assumes that the values of the internal memory locations depend on program instructions (with a signature value substantially synchronous with the execution of instructions by the processing logic), which are executed on the processor. Thus, and notably, any comparison of a signature is performed only in response to a certain software routine being executed.

In some cases, it may be useful to be able to validate an output of a signal generating device, for example a time domain signal generator, rather than simply validating a correct execution order of signature validated instructions of a CPU.

### SUMMARY OF THE INVENTION

The present invention provides a signal integrity module for validating one or more control signals in time domain and a method of operating the signal integrity module as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 schematically illustrates a semiconductor device comprising a processing system;

FIG. 2 schematically shows a block diagram of a processing device exemplified with respect to a system-on-chip (SoC) processing device;

FIG. 3 schematically illustrates a block diagram of a central triggering unit;

FIG. 4 schematically illustrates a block diagram of a simplified example of a signature generation module;

FIG. 5 schematically illustrates a block diagram of a simplified example of a timer architecture for triggering an example signature generation module;

FIG. 6 schematically illustrates a block diagram of a comparator of an example signature generation module;

FIG. 7 schematically illustrates a circuit diagram of a multi-input shift register as an example of a signature generation unit usable in an example signature generation module;

FIG. 8 schematically illustrates a circuit diagram of an example of a Multiple Input Signature Registers (MISRs) with three flip-flops; and

FIG. 9 schematically shows a flow diagram illustrating the flow of operation as performed by an example signature generation module such as that illustrated in FIG. 4.

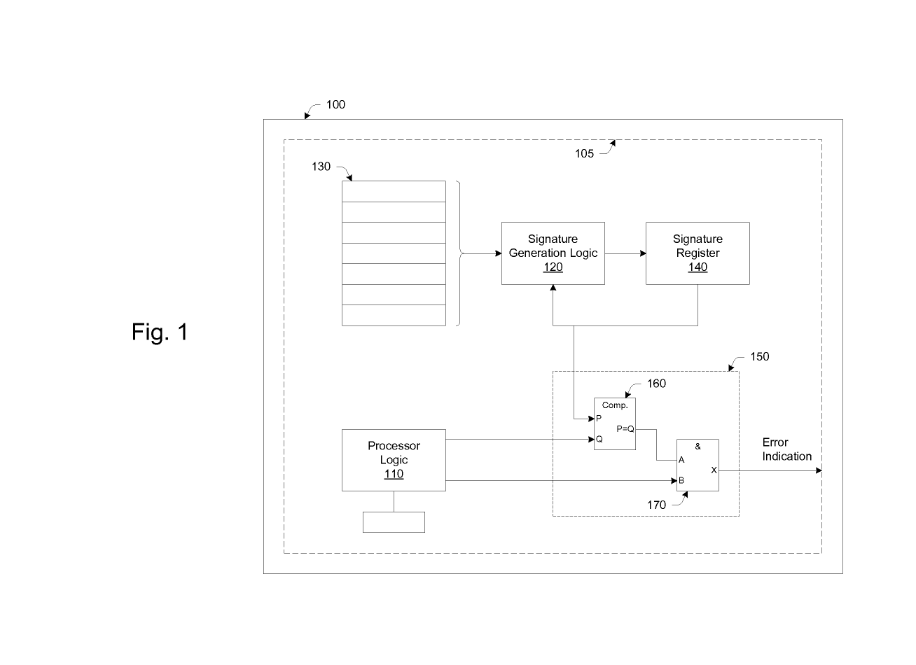

### DETAILED DESCRIPTION

Because the illustrated examples of the present invention may, for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

It is understood that the following disclosure provides many different examples capable of implementing different features. Specific examples of components and arrangements are described below to simplify and thus clarify the present disclosure. These are, of course, merely examples and are not intended to be limiting. In many instances, the features of one example may be combined with the features of other examples. In addition, the present disclosure may repeat reference numerals and/or signs in the various illustrative examples and in particular same reference numerals and/or signs may be used throughout the drawings. This repetition is for the purpose of simplicity and clarity.

Although the examples are described with reference to a signal integrity system having a signature generation module to validate, in real-time, the integrity of time-domain signal generators, it is envisaged that the example concepts described herein may be equally applied to other timing or time-domain signal generation applications.

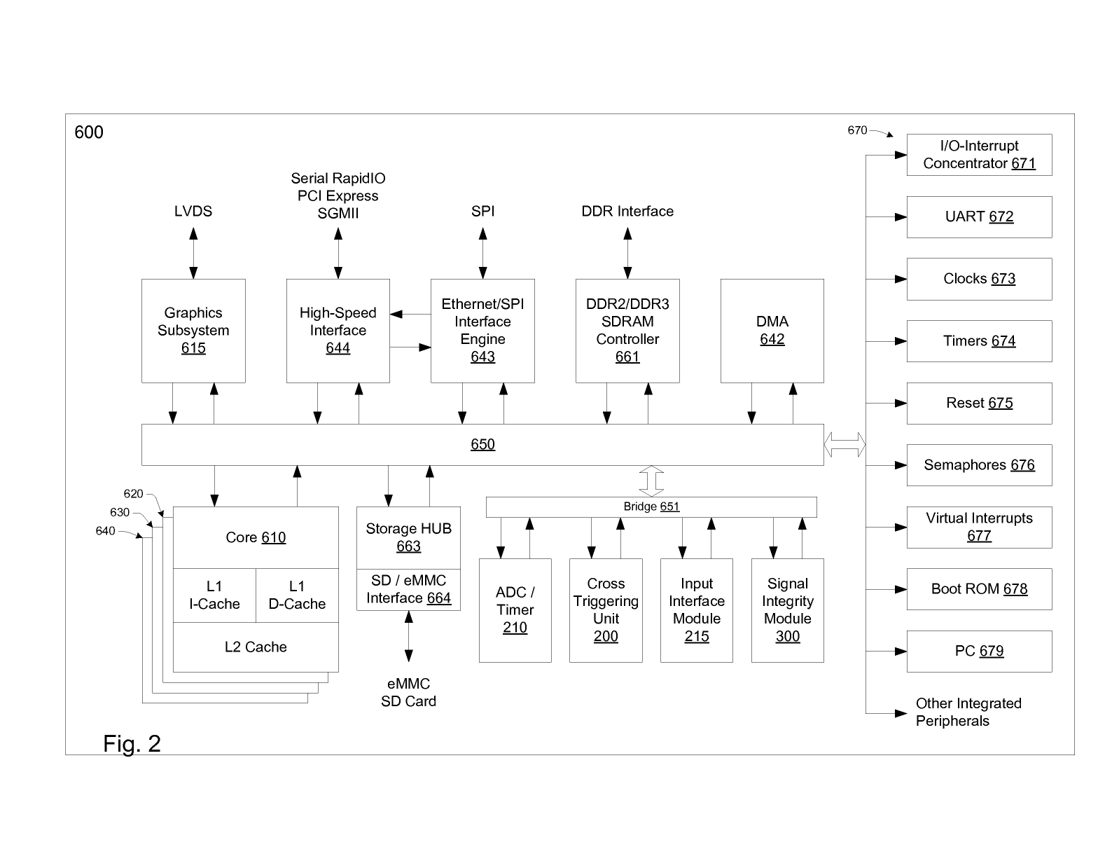

Referring now to FIG. 2, there is shown a simplified schematic diagram of a multi-core system on chip 600 having multiple processor cores 610, 620, 630, 640. The multi-core system on chip 600 should be understood as one example of a data processing device or a data processing system in the context of the present application. As illustrated, each of the processor cores 610, 620, 630, 640 is coupled to one or more levels of cache memory, such as an L1 instruction cache (I-Cache), L1 data cache (D-Cache), and/or L2 cache. While the processor cores 610, 620, 630, 640 may be identically designed or homogenous, the multi-core SoC may also include one or more cores having a different design. For example, the depicted multi-core SoC 600 also includes an accelerator (not shown), which may include one or more processor cores for supporting hardware acceleration for DFT/iDFT and FFT/iFFT algorithms and for CRC processing. Each processor core is coupled across an interconnect bus 650 to one or more memory controllers 661, which are coupled in turn to one or more banks of system memory (not shown). The interconnect bus 650 also couples the processor cores to a Direct Memory Access (DMA) controller 642, network interface 643, a high speed serial interface 644, and to other hardware-implemented integrated peripherals 671 to 679. The interconnect bus 650 may be a coherency fabric.

Each of the processor cores 610, 620, 630, 640 may be configured to execute instructions and to process data according to a particular instruction set architecture (ISA), such as x86, PowerPC, SPARC, MIPS, and ARM, for example. Those of ordinary skill in the art also understand the present invention is not limited to any particular manufacturer's microprocessor design. The processor core may be found in many forms including, for example, any 32-bit or 64-bit microprocessor manufactured by Freescale, Motorola, Intel, AMD, Sun or IBM. However, any other suitable single or multiple microprocessors, microcontrollers, or microcomputers may be utilized. In the illustrated embodiment, each of the processor cores 610, 620, 630, 640 may be configured to operate independently of the others, such that all cores may execute in parallel. In some embodiments, each of cores may be configured to execute multiple threads concurrently, where a given thread may include a set of instructions that may execute independently of instructions from another thread. Such a core may also be referred to as a multithreaded (MT) core. Thus, a single multi-core SoC 600 with four cores will be capable of executing a multiple of four threads in this configuration. However, it should be appreciated that the invention is not limited to four processor cores and that more or fewer cores can be included. In addition, the term “core” refers to any combination of hardware, software, and firmware typically configured to provide a processing functionality with respect to information obtained from or provided to associated circuitry and/or modules (e.g., one or more peripherals, as described below). Such cores include, for example, digital signal processors (DSPs), central processing units (CPUs), microprocessors, and the like. These cores are often also referred to as masters, in that they often act as a bus master with respect to any associated peripherals. Furthermore, the term multi-core (or multi-master) refers to any combination of hardware, software, and firmware that that includes two or more such cores (e.g., cores 610 and 620), regardless of whether the individual cores are fabricated monolithically (i.e., on the same chip) or separately. Thus, a second core may be the same physical core as first core, but has multiple modes of operation (e.g., a core may be virtualized).

As depicted, each processor core (e.g., 610) may include a first level (L1) cache, which includes a data cache (D-Cache) and an instruction cache (I-Cache). In addition, a second level of cache memory (L2) may also be provided at each core, though the L2 cache memory can also be an external L2 cache memory, which is shared by one or more processor cores. The processor core 610 executes instructions and processes data under control of the operating system (OS), which may designate or select the processor core 610 as the control or master node for controlling the workload distribution amongst the processor cores 610, 620, 630, 640. Communication between the cores 610, 620, 630, 640 may be over the interconnect bus 650 or over a crossbar switch and appropriate dual point to point links according to, for example, a split-transaction bus protocol such as the HyperTransport (HT) protocol (not shown). Those skilled in the art will understand that the control functionality may not be exclusively assigned to one of the processor cores 610, 620, 630, 640. The control functionality may be distributed among the processor cores 610, 620, 630, 640.

The processor cores 610, 620, 630, 640 and accelerator 641 are in communication with the interconnect bus 650, which manages data flow between the cores and the memory. The interconnect bus 650 may be configured to concurrently accommodate a large number of independent accesses that are processed on each clock cycle, and enables communication data requests from the processor cores 610, 620, 630, 640 to external memory and/or an on-chip memory (not shown), as well as data responses therefrom. The external memory and/or an on-chip memory may comprise volatile memory technology and/or non-volatile memory technology. In selected embodiments, the interconnect bus 650 may include logic (such as multiplexers or a switch fabric, for example) that allows any core to access any bank of memory, and that conversely allows data to be returned from any memory bank to any core. The interconnect bus 650 may also include logic to queue data requests and/or responses, such that requests and responses may not block other activity while waiting for service. Additionally, the interconnect bus 650 may be configured as a chip-level arbitration and switching system (CLASS) to arbitrate conflicts that may occur when multiple cores attempt to access a memory or vice versa.

The interconnect bus 650 is in communication with main memory controller 661 to provide access to the optional SOC internal memory or main memory (not shown). Memory controller 661 may be configured to manage the transfer of data between the multi-core SoC 600 and system memory, for example. In some embodiments, multiple instances of memory controller 661 may be implemented, with each instance configured to control a respective bank of system memory. Memory controller 661 may be configured to interface to any suitable type of system memory, such as Double Data Rate or Double Data Rate 2 or Double Data Rate 3 Synchronous Dynamic Random Access Memory (DDR/DDR2/DDR3 SDRAM), or Rambus DRAM (RDRAM), for example. In some embodiments, memory controller 661 may be configured to support interfacing to multiple different types of system memory. In addition, the Direct Memory Access (DMA) controller 642 may be provided, which controls the direct data transfers to and from system memory via memory controller 661.

The interconnect bus 650 is in communication with storage HUB 663 to provide access to mass storage (not shown). The storage HUB 663 may be configured to manage the transfer of data between the multi-core SoC 600 and mass storage units, for example. The storage HUB 663 may further include one or more interfaces specific for the technology used by the mass storage units. Herein, the storage HUB 663 is exemplarily illustrated to include a SD/eMMC Interface 664, which is provided to allow for access to SD (Secure Data), MMC (MultiMediaCard) cards (not shown) and/or eMMC (embedded MultiMediaCard) (not shown). Both storage technologies are implemented on the basis of non-volatile flash memory technology. In some embodiments, multiple instances of storage HUB 663 and/or interfaces provided with the storage HUB 663 may be implemented, with each instance configured to control a respective bank of system memory. Memory storage HUB 663 may be configured to interface to any suitable type of mass storage interfacing standards including in particular flash memory storage standards (SD, MMC), SAS (Serial Attached SCSI), SATA (Serial ATA) and the like.

The multi-core SoC 600 may comprise a dedicated graphics sub-system 200. The graphics sub-system 200 may be configured to manage the transfer of data between the multi-core SoC 600 and graphics sub-system 200, for example, through the interconnect bus 650. The graphics sub-system 200 may include one or more processor cores for supporting hardware accelerated graphics generation. The graphics generated by the graphics sub-system 200 may be outputted to one or more displays via any display interface such as LVDS, HDMI, DVI and the like.

As will be appreciated, the multi-core SoC 600 may be configured to receive data from sources other than system memory. To this end, a network interface engine 643 may be configured to provide a central interface for handling Ethernet and SPI interfaces, thus off-loading the tasks from the cores. In addition, a high speed serial interface 644 may be configured to support one or more serial RapidIO ports, a PCI-Express Controller, and/or a serial Gigabit Media Independent Interface (SGMII). In addition, one or more interfaces 670 may be provided, which are configured to couple the cores to external boot and/or service devices, such as I/O interrupt concentrators 671, UART device(s) 672, clock(s) 673, timer(s) 674, reset 675, hardware semaphore(s) 676, virtual interrupt(s) 677, Boot ROM 678, 12C interface 679, GPIO ports, and/or other modules.

Instructions for the operating system, applications, and/or programs may be in mass storage or memory, which are in communication with processor cores 610, 620, 630, 640 through communications fabric 650. In these illustrative examples, the instructions are in a functional form on a non-transitory tangible medium such as a persistent mass storage. These instructions may be loaded into memory for running by processor cores 610, 620, 630, 640. The processes of the different examples may be performed by processor cores 610, 620, 630, 640 using computer implemented instructions, which may be in a memory. These instructions are referred to as program code, computer usable program code, or computer readable program code that may be read and run by one or more processor cores 610, 620, 630, 640 in the SoC 600. The program code in the different embodiments may be embodied on different physical or computer readable non-transitory tangible storage media.

Program code may be in a functional form on computer readable medium that may be selectively removable and may be loaded onto or transferred to data processing system for running by the one or more processor cores. Program code and computer readable medium form computer program product in these examples. In one example, computer readable medium may be computer readable non-transitory tangible storage medium. Computer readable storage medium may include, for example, an optical or magnetic disk that may be inserted or placed into a drive or other device that may be part of persistent storage for transfer onto a mass storage device, such as a hard drive, that may be part of persistent storage. Computer readable storage medium also may take the form of a persistent storage, such as a hard drive, a thumb drive, or a flash memory, that may be operably coupled to data processing system. In some instances, computer readable storage medium may not be removable from data processing system.

The SoC 600 may be used to control an external apparatus (not shown). One or more of the processor cores 610, 620, 630, 640 may be configured to control the apparatus in accordance with a control algorithm.

The apparatus may be controlled by the SoC 600 in accordance with a PWM (Pulse Width Modulation) technique. In particular, the apparatus may be a three phase electrical motor or an air bag system having structures and operations known to those skilled in the art. The present description will refer to the particular case, in which the apparatus is a three phase electrical motor, but other types of devices to be controlled can be utilized. It should be noted that the description referring to the apparatus is included to enhance the intelligibility of the overall teaching and should not understood to limit the scope of the present application.

An input interface module 215 is connectable to the external apparatus, e.g. the three phase electrical motor, and is configured to detect state signals and to supply them to a signal acquisition managing device 200, which, without limiting the scope of the present application, is also referred to as central triggering unit (CTU). As an example, the state signals are digital or analogue signals representing state parameters of the three phase electrical motor or positions of further actuators employed for the apparatus control. Moreover, according to an example, the state signals can include signals representing the generated PWM signals to be applied to the actuators or real PWM signals applied to the actuator or signals representing an external synchronization event. Particularly, the state signals may represent electrical currents or angular positions of the rotor included in the three phase electrical motor. The input interface module 215, e.g. configured for being connected to a three phase electric motor, may include at least one unit of the group comprising: a Pulse Width Modulation duty cycle encoder, an input analogue-to-digital converter, a sensor, a time unit, a position counter, a quadrature decoder, a resolver, and a sine-cos sensor. For instance, the input interface module 215 is configured to supply to the signal acquisition managing device 200 a control period signal indicating the PWM control period.

A peripheral module 210 may be configured to receive the synchronized command signals from the signal acquisition managing device 200, to perform actions corresponding to the commands represented by the command signals, and to generate output signals carrying data to be processed by at least one of the processor core 610, 620, 630, 640 in accordance with the control algorithm. As illustrated, the peripheral module 210 can include at least one output analog-to-digital converter ADC configured to receive first synchronized command signals and generate digital state signals and at least one output timer TMR configured to receive second synchronized command signals and generate measured signals. The output analog-to-digital converter ADC and the output timer TMR may be activated by the corresponding synchronized command signals in order to perform the corresponding action on the state signals provided by the input interface module 215 (such as AD conversions and timer measurements) and to produce the output signals carrying data concerning the behavior of the three phase electrical motor.

The signal acquisition managing device or cross triggering unit (CTU) 200, the peripheral module 210 and the input interface module 215 may be coupled to the interconnect bus 650 for instance via a (I/O) bridge 651.

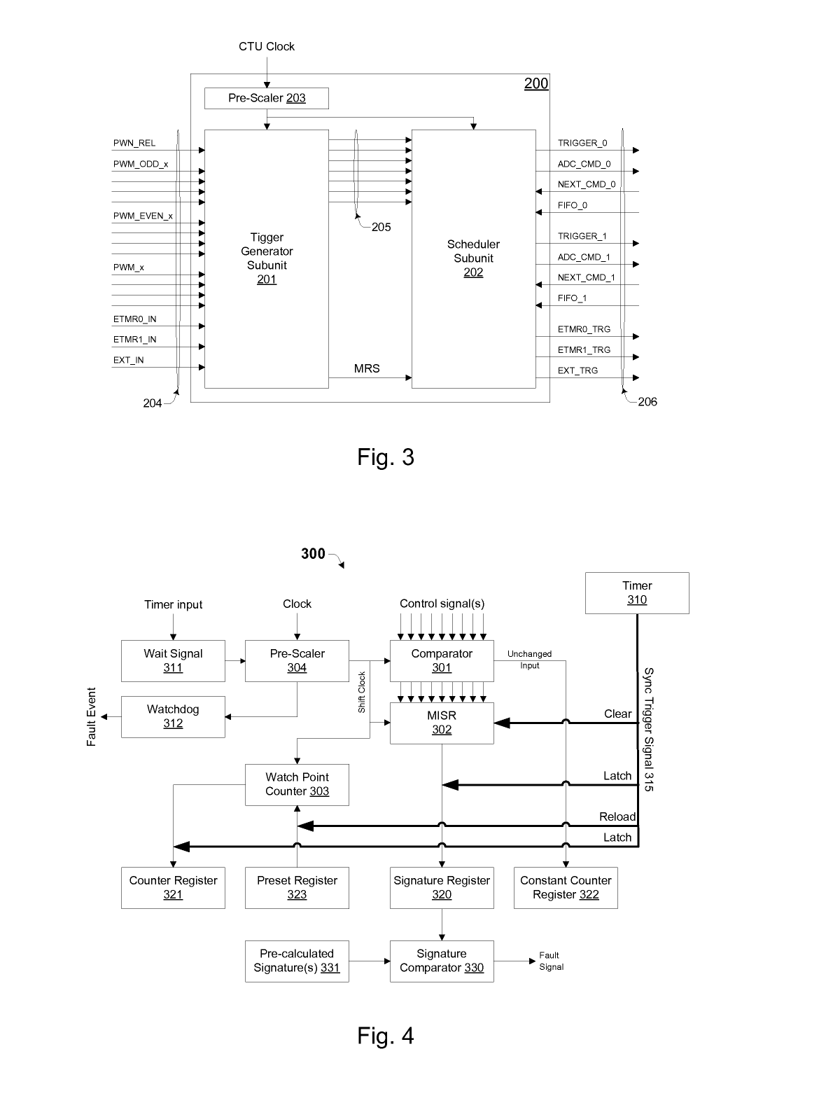

FIG. 3 illustrates by functional blocks an example of the signal acquisition managing device or central triggering unit (CTU) 200 including a plurality of input terminals 204 for the state signals, a trigger generation subunit 201 and a scheduler subunit 202. The trigger generation subunit 201 is configured to build from the state signals a reference signal MRS and also, based on said reference signal MRS, to generate event trigger signals (on intermediate outputs 205), each representing the time, in which an event has to be performed.

The scheduler subunit 202 is configured to associate each event trigger signal with a specific action and generate the corresponding synchronized command signal, to be supplied by means of respective output terminals 206, for instance towards a specific peripheral device of the peripheral module 210. Each synchronized command signal represents an action to be performed by the corresponding peripheral device, e.g., a conversion to be carried out by the output analog-to-digital converter ADC or a measure to be carried out by the output timer TMR included in the peripheral module 600. As an example, a synchronized command signal provided to the output analog-to-digital converter ADC indicates, which input channel among a plurality of channels entering the output analog-to-digital converter ADC has to undergo the conversion.

According to an example of the present application, the signal acquisition managing device 200 illustrated in FIG. 3 is adapted to receive state signals from the following peripheral devices included in the input interface module 215: a PWM encoder, two timers and an external pin. The external pin is available to receive, for this purpose, the signal acquisition managing device 200 that is provided with sixteen input terminals 204 for receiving thirteen state input signals for the PWM duty cycle decoder (i.e., signals PWM_REL, PWM_ODD_x, . . . , PWM_EVEN_x, RPWM_x, . . . ), two state input signals from the timers (i.e., signals ETMR0_IN and ETMR1_IN) and one state input signal from the external pin (i.e., signal EXT_IN). In this example, the state signals are digital signals. Of course, the signal acquisition managing device 200 can include a different number of input or output terminals.

With reference to the output behavior, the signal acquisition managing device 200 depicted in FIG. 3 is adapted to provide the following synchronized command signals to the peripheral devices included in the peripheral module 600: two synchronized command signals for the two output analog-to-digital converters ADC: first command signal ADC_CMD_0 and second command signal ADC_CMD_1; two trigger signals for the two output analog-to-digital converters ADC: first trigger signal TRIGGER_0 and second trigger signal TRIGGER_1; two triggers signals for the corresponding output timers TMR: third trigger signal ETIMER0_TRG and fourth trigger signal ETIMER1_TRG; and a trigger signal for the external pin: fifth trigger signal EXT_TRG. In accordance with the example given, the above indicated synchronized command signals are digital signals.

Moreover, the scheduler subunit 202 may be provided with two input terminals for receiving corresponding signals NEXT-CMD_0 and NEXT-CMD_1 generated by the two output analog-to-digital converters ADC and indicating the next synchronized command signals to be generated by the signal acquisition managing device 200. In addition the scheduler subunit 202 includes further input lines for receiving signals FIFO_0 and FIFO_1 carrying data resulting from the conversion made by the two output analog-to-digital converters ADC, which can be stored in suitable FIFO (First In First Out) memories included in the scheduler subunit 202. A pre-scaler 203 applying a frequency division (e.g., according to factors 1, 2, 3 or 4) of a CTU clock signal is also included in the signal acquisition managing device 200.

With regard to the above description, it is readily understood that control signal generating circuits are applied in control applications, in which processing microcontrollers are arranged to control the control signal generating circuits. The signals outputted by the control signal generating circuits are deterministic in time. For instance, a specific PWM signal is expected to have a given duty cycle and period in accordance with the control algorithm performed by a data processing unit operating as controller unit. Furthermore, complex control application may further require trigger sequences including e.g. starting an ADC, moving data by an ADC, triggering timer(s) etc., as illustrated above with reference to the example three phase electric motor and inter alia the signal acquisition managing device 200.

In the present application, a signal integrity module 300 is suggested and exemplified, which allows for validating the integrity of control signals in time domain, in particular control signals generated by signal generator circuits, which are periodic in time. In order to enable the validation of a control signal, the control signal is monitored and a signature is calculated on the basis of the monitored control signals outputted by the control signal generator circuit at different points in time. At a watch point, the calculated signature is compared to an expected reference value. The expected reference value may be pre-calculated.

In the context of an example of a signal integrity module 300, a control signal to be validated should be understood as signal having states representable in binary coding. For instance, a control signal may be a binary logic signal or dual-value logic signal coding two distinct states. However, a control signal may also represent more than two states, which are represented by two or more binary logic signals.

Referring to FIG. 4, the signal integrity module 300 comprises a Multiple Input Shift Register (MISR) 302, to which the one or more control signals to be monitored are supplied.

Linear Feedback Shift Registers (LFSR) are known in the art to compress an input bit stream to a single value. The basic principal is that the input polynomial (stream) gets divided by the characteristic polynomial of the LFSR, resulting in a quotient (output stream) and a remainder. Because this may be understood as a “lossy” compression scheme, there is more than one input stream that can generate a specific signature. The occurrence of an erroneous input stream that generates a correct signature is called aliasing. However, the probability of aliasing can be considered as very small. Insofar, LFSR have been proven to be suitable to generate signatures to validate the integrity of a bit stream.

The signature generated by a Linear Feedback Shift Register can be mathematically described. Accordingly, a signature can be pre-calculated if the input bit sequence inputted to a Linear Feedback Shift Register and the characteristics of the Linear Feedback Shift Register is known.

A Multiple Input Shift Register also known as Multiple Input Signature Analysis Register is a variation of a Linear Feedback Shift Registers providing a plurality of inputs, at which a set of bits are inputted in parallel. An implementation of an exemplary Multiple Input Shift Register (MISR) will be described in more detail with reference to FIG. 7.

However, it should be noted that the Multiple Input Shift Register (MISR) 302 used in the example of a signal integrity module 300 for sampling a control signal sequence and generating a signature thereof is only one specific example of a signal sampling and signature generating circuit applicable with the signal integrity module 300 according to examples of the present application. More generally, the Multiple Input Shift Register (MISR) 302 exemplified in FIG. 4 should be understood to represent a register, which is configured to accept a sequence of one or more bit signals varying in time, to sample the one or more bit signals at a watch point and to generate a signature representative of the one or more bit signals monitored at several watch points. The register comprises n inputs for each one for an input bit signal and m internal bit states, the sequence of which represent the signature with a length of m bits.

As further illustrated in FIG. 4, an input signal comparator 301 may be arranged upstream to the Multiple Input Shift Register (MISR) 302. The input signal comparator 301 is further exemplified with reference to FIG. 6 and comprises a latch 305 storing the status/values of the one or more bit signals at a previous watch point. By comparing the status/values of the one or more bit signals at a current watch point and the status/values of the one or more bit signals a previous watch point, it can be determined whether the signal input to the signal integrity module 300 has been changed or is unchanged. A repeated input of unchanged values to Linear Feedback Shift Registers (LFSR) and in particular the Multiple Input Shift Register (MISR) 302 should be omitted. A constant counter 322 is provided, which receives a count signal from the input signal comparator 301 and increases by a predetermined increment value upon indication of an unchanged input at a watch point.

A pre-scaler 304 of the signal integrity module 300 generates a shift clock signal, which signalized the watch points to the input signal comparator 301 and the Multiple Input Shift Register (MISR) 302, which operate accordingly. The pre-scaler 304 may be configured to apply a frequency division (e.g., according to factors 1, 2, 3 or 4) of a clock signal supplied to the signal integrity module 300. Alternatively, the signal integrity module 300 may include a clock signal generator, which is configured to generate the shift clock signal. Such a clock signal generator may be configurable such that the frequency of the shift clock signal generated thereby is adaptable to the one or more control signals to be monitored.

The pre-scaler 304 or the clock signal generator may be de-activatable to suppress/inhibit the outputting of the shift clock signal. For instance, the signal integrity module 300 comprises an input for a wait signal 311 of e.g. an external timer to suppress/inhibit the outputting of the shift clock signal.

The number of watch points, at which the one or more control signals are monitored is counted. The exemplary signal integrity module 300 comprises a watch point counter 303, which counts in response to the shift clock signal supplied thereto. As illustratively shown, the watch point counter 303 may be a down counter, which decrements its counter value by a predetermined decrement value in response to the shift clock signal. Alternatively, an up counter may be used, which increments its counter value by a predetermined increment value in response to the shift clock signal.

Upon a sync trigger signal 315 after a defined period in time, the status and values of the Multiple Input Shift Register (MISR) 302 and the watch point counter 303 are latched into respective registers, a counter result register 321 and a signature register. After the status and values of the Multiple Input Shift Register (MISR) 302 and the watch point counter 303 having been latched, the Multiple Input Shift Register (MISR) 302 and the watch point counter 303 are reset to a predefined state and a predefined value for a subsequent period of time.

The signal integrity module 300 may comprise a present register 323 for storing a predefined counter value, which is loaded into the watch point counter 303 at a reset thereof.

The Multiple Input Shift Register (MISR) 302 may be set into a predefined initial state at reset. The predefined state comprise all internal bit states set to logical 0 or logical 1. The initial state of the Multiple Input Shift Register (MISR) 302 may alternate between the above mentioned predetermined states at each reset in order to implement a life counter.

The registers 320 to 322 may be as a set of memory locations through memory mapped registers (MMR) or memory-mapped input/output (MMIO). The registers may be readable and writable. Writable registers e.g. enables to validate whether the registers are updated with the values and states of the counters and registers of the signal integrity module 300. The access to the registers may be performed through an application programming interface (API) interfacing between software application(s) and the registers implemented in hardware.

The sync trigger signal 315 may be provided in accordance with a periodicity of the one or more control signals supplied to the signal integrity module 300. For instance, the sync trigger signal 315 may be outputted by a timer 310, which may be a timer internal to the signal integrity module 300 and configurable to be adaptable to e.g. the signal periodicity or a timer external to the signal integrity module 300, which outputs a trigger signal e.g. corresponding to the signal periodicity.

A watchdog 312 may be further included in the signal integrity module 300, which monitors the pre-scaler 304 in order to detect whether the pre-scaler 304 generates a subsequent watch point signal within a predefined maximum period of time, which is for instance not the case when the time period within which a wait signal is active (which means that outputting of the shift clock signal is suppressed/inhibited) exceeds a predefined maximum period of time. In other words, the watchdog 312 is provided to detect inter alia whether the wait signal is active for a period of time, which is too long. The watchdog 312 may be configured to indicate such a fault event for instance by initiating an error flag.

The signal integrity module 300 may further comprise a signature comparator 330, which compares the signature stored in the signature register 320 with a pre-calculated signature, which may be provided in a readable and writable signature storage 331. In case the signature stored in the signature register 320 does not match with the pre-calculated signature, a fault signal may be generated and outputted to signalize the mismatch.

In this manner, the examples herein described may perform a signal integrity check dependent upon a characteristic (e.g. period) of the one or more control signal(s) being inputted thereto. Due to the novel architecture illustrated and described implementation, as compared to a traditional solution, the described approach may be more resistant to common mode failures. Furthermore, due to the signal integrity self-checking capabilities in some optional examples, the described approach may detect permanent and transient faults. In this manner, the described approach may supports various types of modules generating a deterministic changing control signal output.

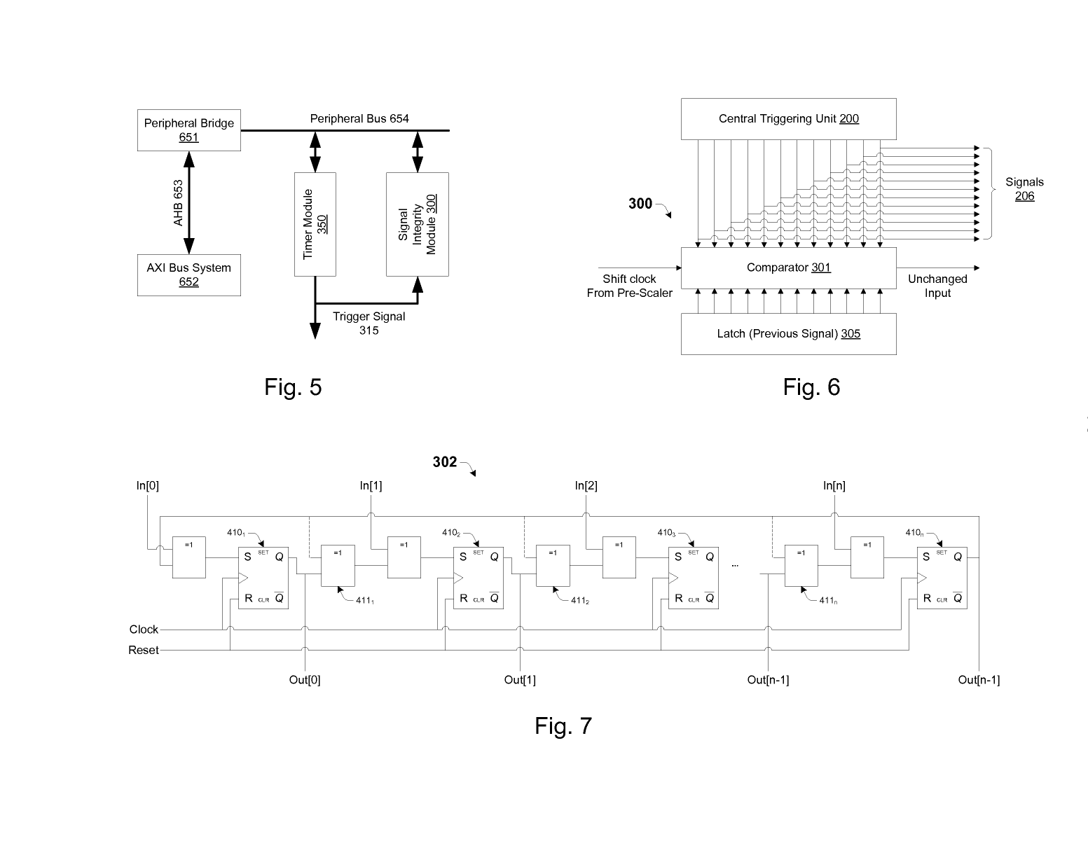

Referring now to FIG. 5, the sync trigger signal 315 may be supplied by a timer module 350 implemented in the SoC 600. In one example, the timer module 350 may be an Enhanced Motor Control Timer (eTimer) module, which is configured to drive various motor types including e.g. stepper, brushless direct current (BLDC) and multi-axis programmable controlled (PMAC) motors with sensor and sensor-less algorithms. The timer module 350 may comprise a built-in quadrature detector to detect a rotational speed of a motor. The signal integrity module 300 and the timer module 350 may be coupled to the interconnect bus 650 via a bridge 651. As exemplarily illustrated in FIG. 5, the signal integrity module 300 and the timer module 350 may be coupled to the interconnect bus 650 via e.g. may be a 64-bit advanced high-performance bus (AHB) 653 of an Advanced eXtensible Interface (AXI) bus system 652 and a peripheral (I/O) bridge 651 interfacing between a 32-bit peripheral bus 654 and the 64-bit advanced high-performance bus (AHB) 653. The signal acquisition managing device or cross triggering unit (CTU), the peripheral module and the input interface module (not shown in FIG. 5) may be also coupled to the 32-bit peripheral bus 654.

The signal integrity module 300 receives the one or more control signals, which are monitored, through the bus, to which it is coupled, in particular through the peripheral bus 654. The signal integrity module 300 may receive any control signals present at the bus. In one example, the signal integrity module 300 comprises a bus interface and signal selector to receive control signals present at the bus and select one or more control signals (to be monitored) among the received control signals.

Referring to FIG. 6, the control signals monitored by the signal integrity module 300 may be supplied by a signal acquisition managing device or cross triggering unit (CTU) 200 as exemplified above with reference to FIG. 3. In particular the trigger signals generated by the signal acquisition managing device or cross triggering unit (CTU) 200 may be monitored by the signal integrity module 300. However, those skilled in the art will understand on the basis of the description of the present application that the signal integrity module 300 is not limited to monitoring trigger signals generated by a signal acquisition managing device or cross triggering unit (CTU) 200. Any signals, which are deterministic in time and in particular periodic in time may be monitored by the signal integrity module 300 may monitored and the signal integrity over time may be validated on the basis of a recalculated signal signature. The control signals may include, without limited thereto, timer signals, interrupt signals, waveform generator generated signal etc.

Referring now to FIG. 7, signature generating circuits are known in the field of testing integrated circuits. Test vectors are applied as test inputs to a circuit under test (CUT) or device under test (DUT). The monitored signals of the CUT are provided as inputs to a signature generating circuit. Such signature generating circuits combine monitored signals from the CUT with a stored value of the signature register (a “current” value) to create a new signature register value for each test vector is applied to the CUT. At the end of the set of test vectors, the contents of the signature register (e.g., the “signature”) is compared to an expected signature for a fault-free circuit, which is typically calculated via a simulation.

The combining of a monitored signal with a prior signature register value typically includes a mathematical operation. If multiple signals are simultaneously provided as inputs to the signature register, the signature register is typically referred to as a Multiple Input Signature Register (MISR). One mathematical operation used with a MISR maintains a running odd-parity in each bit of the signature register of corresponding input signals. Other techniques combine multiple input signals and multiple signature register bits in some linear combination to create the next MISR state.

Generally, the greater the complexity of this operation, the better the fault coverage. More complex operations, however, can place limits on the speed, at which Multiple Input Signature Register (MISR) can be run. For example, each increase in the depth of the logic used to generate a new Multiple Input Signature Register (MISR) value increases the propagation delay to the input of the MISR's register. Also, if the input signal is used as an input to multiple gates within the MISR, the MISR's multiple gates increase the capacitive load limiting the speed of operation.

Multiple Input Signature Registers (MISRs) are implemented to perform a linear operation on a combination of the inputs to the MISR and the MISR's current state values to create the next MISR state. MISRs are also referred to as signature space compactor circuits since MISRs produce a signature with relatively few bits at the end.

FIG. 7 shows a schematic circuit diagram of an example Multiple Input Signature Register (MISR). Referring to FIG. 7, the example MISR includes flip-flops 410₁ to 401ₙ for storing data of 1 bit and XOR gates 410₁ to 401ₙ representing the coefficients of a primitive polynomial. The MISR of FIG. 7 receives and processes the data In[0] to In[n] in parallel. The number of flip-flops in the MISR of FIG. 7 is determined in accordance with the number of binary logic or dual-value logic input signals to the MISR. The MISR of FIG. 7 performs the following primitive polynomial:

P=1+C₁X¹+C₂X²+ . . . +CₙXⁿ,

where Cᵢ denotes the coefficient of the respective terms of the above equation. If the coefficient of the term is ‘1’, a feedback path exists, while if the coefficient is ‘0’, no feedback path exists as illustrated in FIG. 7 by dashed lines.

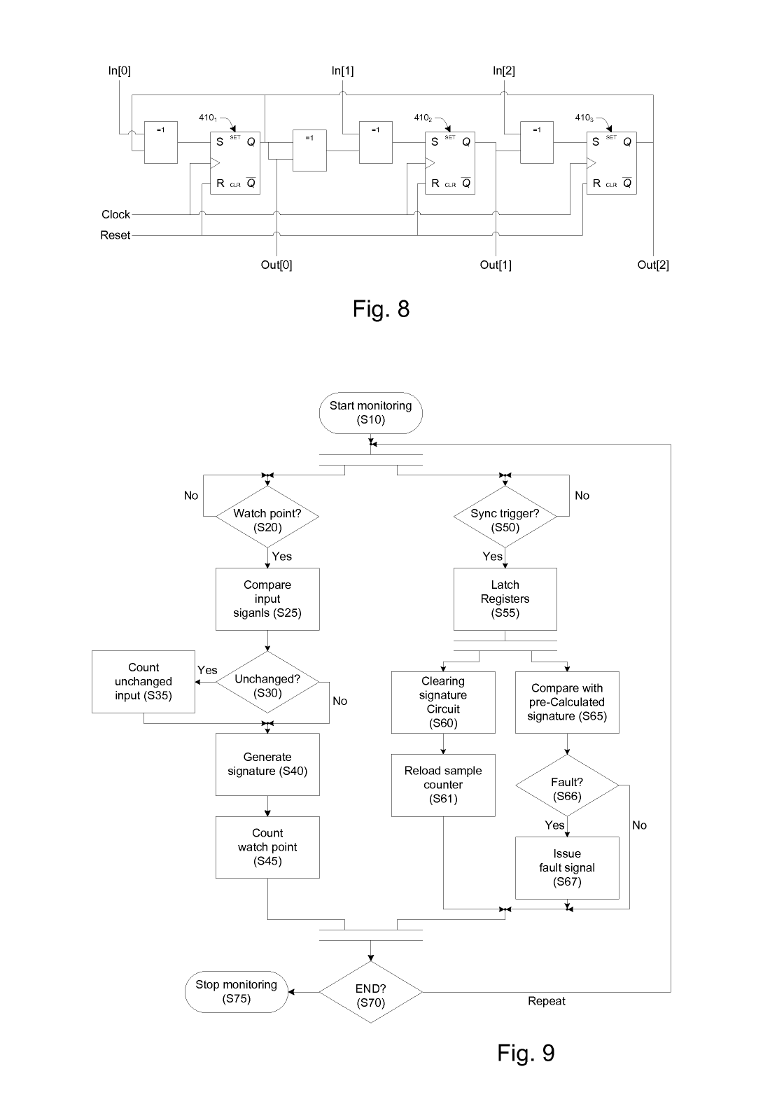

With reference to FIG. 8, a schematic circuit diagram of an example of a Multiple Input Signature Register (MISR) with three flip-flops is illustrated. The primitive polynomial performed by the MISR is following:

P=1+X¹+X³.

The input and output of the MISR may be calculated as following:

$$[ \begin{matrix}Out [ 0 ] ( t + 1 ) \\ Out [ 1 ] ( t + 1 ) \\ Out [ 2 ] ( t + 1 )\end{matrix} ] = [ \begin{matrix}0 & 0 & 1 \\ 1 & 0 & 1 \\ 0 & 1 & 1\end{matrix} ] [ \begin{matrix}Out [ 0 ] ( t ) \\ Out [ 1 ] ( t ) \\ Out [ 2 ] ( t )\end{matrix} ] + [ \begin{matrix}In [ 0 ] ( t ) \\ In [ 1 ] ( t ) \\ In [ 2 ] ( t )\end{matrix} ] ,$$

wherein t represents a current watch point and t+1 the successive watch point. Referring now to FIG. 8, a flow chart illustrates the operation performed by an example of a signal integrity module such as that shown in FIG. 4 and described above with reference thereto.

At S10, the signal integrity module 300 starts validating the integrity of one or more control signals received from one or more time based signal generator modules. The flow of operation may comprise two substantially independent flows of operation carried out in parallel. One operation flow relates to the monitoring of the inputted control signal(s) and generating of a signature of the monitored control signal(s) in real-time. The other operation flow relates to the validating of the generated signature with a pre-calculated signature to verify the integrity of the monitored control signal(s). For the sake of the following description, the term input signal should be understood to relate to the one or more control signals imputed to the signal integrity module 300.

At S20, it is determined whether a watch point is reached. The point in times, at which watch points occur, are adapted to rate, at which the input signal is expected to change. Upon reaching a watch point (e.g. defined by the shift clock), the input signal is compared with an input signal latched at a previous watch point at S25 to determine at S30 whether the input signal has been changed or not. If the input signal is determined to be unchanged with regard to the latched input signal, a counter counting the detecting events of unchanged input signals is increased. It should be noted that the counter counting the detecting events may be alternatively decreased string from an initial (pre-set) value. The counter value reaching a threshold value may be indicative of the inputted one or more control signals being faulty.

At S40, the input signal is inputted to the signature generating circuit such as the multiple input signature register (MISR) 302, which generates a new signature on the basis of the current signature and the input signal. The signature generating circuit generates a real-time signature of the input signals inputted to the signal integrity module 300 over a monitoring period. The monitoring period is the period of time between successive sync trigger signals 315.

At S45, the watch point is counted. As exemplified above with reference to FIG. 4, the watch point counter may be a down counter, the value of which is decreased with each watch point.

The operation flow relating to the monitoring and generating of a signature of the control signal(s) is repeated (S70) unless the validation of the signal integrity performed by the signal integrity module 300 is stopped.

At S20, it is determined whether a sync trigger signal occurs at or is received by the signal integrity module 300. Upon a sync trigger signal, the current signature of the signature generating circuit and value of the watch point counter are latched into the registers 320 and 321.

Further, a new monitoring period starts with sync trigger signal. Accordingly, the signature present at the signature generating circuit is cleared, which means that the signature storage cells at the signature generating circuit are set to predefined values such as all cells are set to logical 1 or logical 0. The signature storage cells may alternatingly set to logical 1 and logical 0. At S61, the watch point counter is set to a predefined counter value, which may be provided in the pre-set register 323 and loaded from the pre-set register 323 to the watch point counter 303.

The operation flow relating to the monitoring and generating of a signature of the control signal(s) is repeated (S70) unless the validation of the signal integrity performed by the signal integrity module 300 is stopped.

Once the current signature of the signature generating circuit is latched into the signature register (in response to the sync trigger signal) the latched signature is available to be compared to a pre-calculated signature. The signature is generated from the one or more control signal monitored at watch points such that the signature is representative of the time course of the control signal train at distinct point in times (watch points) over the monitoring period (period between successive sync trigger signals). Provided that the one or more control signals monitored by the signal integrity module 300 are deterministic, the signature is pre-calculable. The comparison of the latched signature and the pre-calculated signature hence allows to verify whether the one or more control signals are faulty or not at S66. If the latched and pre-calculated signatures do not match, a fault signal may be generated and issued by the signature comparator 330. In this example, the signature comparison and the signature comparator may be implemented in software or hardware

On the basis of the signature comparison and further in conjunction with the constant counter 322 it is possible to detect and distinguish different fault events including e.g.
a change of the state of one or more control signals occur too early or too late;
the state of one or more control signals does not change (“stuck-at”);
a wrong signal undergoes a change of state (“masquerade”); and
one or more control signals oscillate.

Due to the diverse implementation of this approach, an advantage may be that aspects of the invention may be resilient to common mode failures. Further, due to the signal integrity and self-checking capabilities, detection of permanent and transient faults may be possible. It should also be noted that the signal integrity module is applicable to validate the integrity of any a deterministic changing signal(s) in particular deterministic slow changing signal(s).

According to an example of the present application, a signal integrity module 300 for validating one or more control signals in time domain is provided. The signal integrity module comprises a signal input to receive the one or more control signals. The one or more control signals are received from at least one control signal generating unit. The one or more control signals are changing in time. The signal integrity module further comprises a watch point generating unit 304 configured to generate watch point signals. The signal integrity module further comprises a signature generating unit 302 operably coupled to the signal input to receive the one or more control signals and the watch point generating unit. The signature generating unit is configured to generate a new signature on the basis of a current signature and the state of the one or more control signals at a watch point signalized by the watch point signal. The signal integrity module further comprises a signature register 320 operably coupled to the signature generating unit and configured to latch the current signature upon receiving a trigger signal thereat. The latched signature is representative of the time course of the one or more control signals at the watch point over a monitoring period defined by the trigger signal. The signal integrity module further comprises a signature comparator 330 operatively coupled to the signature register and configured to compare the latched signature with a pre-calculated signature to validate the integrity of the one or more control signals with respect to the time domain.

According to an example of the present application, the signal integrity module further comprises a watch point counter 303 operatively coupled to the watch point generating unit and configured to count the watch point signals generated thereby.

According to an example of the present application, the signal integrity module further comprises a counter register 321 operatively coupled to the watch point counter and configured to latch the current value of the watch point counter upon receiving the trigger signal thereat.

According to an example of the present application, the signal integrity module further comprises an input comparator 301 operatively coupled to the signal input and configured to compare current states of the one or more control signals with states of the one or more control signals latched previously in order to detect whether the states of the one or more control signals have been changed. The previously latched states of the one or more control signals are latched at a previous watch point. In particular, the previously latched states of the one or more control signals are latched at the preceding watch point.

According to an example of the present application, the signal integrity module further comprises a constant counter 322 operatively coupled to the input comparator and configured to count each detection of unchanged states of the one or more control signals.

According to an example of the present application, the signal integrity module further comprises a watchdog 312 operably coupled to the watch point generating unit and configured to generate a fault event in case the watch point generating unit does not generate a watch point signal within a predefined period of time.

According to an example of the present application, the signature generating unit 302 is configured to generate a real-time signature based on the current signature and the state of the one or more control signals at the watch point.

According to an example of the present application, the one or more control signals are dual-value signals.

According to an example of the present application, wherein the watch point generating unit 304 is configured to generate a clock signal to signalize the watch points.

According to an example of the present application, the watch point generating unit 304 is pre-scaler, which is configured to receive a clock signal and to scale the frequency of the received clock signal by a predefined factor. The pre-scaler is configurable to allow adapting the predefined factor to a periodicity of the one or more control signals.

According to an example of the present application, the watch point generating unit 304 is clock signal generator, which is configured to generate the clock signal at a predefined frequency. The clock signal generator is configurable to allow adapting the predefined frequency to a periodicity of the one or more control signals.

According to an example of the present application, the signature generating unit 302 is a multiple input signature register and the watch point signal is a shift signal, which is supplied to the multiple input signature register.

According to an example of the present application, the one or more control signals are deterministic and periodic in time.

According to an example of the present application, a method for validating the integrity of one or more control signals in time domain is provided. The one or more control signals are received via a signal input from at least one control signal generating unit. The one or more control signals are changing in time. Watch point signals are provided by a watch point generating unit. A new signature is generated by a signature generating unit on the basis of a current signature and the state of the one or more control signals at a watch point signalized by the watch point signal. The current signature is latched into a signature register upon receiving a trigger signal thereat. The latched signature is representative of the time course of the one or more control signals at the watch point over a monitoring period defined by the trigger signal. The latched signature is compared by a signature comparator with a pre-calculated signature to validate the integrity of the one or more control signals with respect to the time domain.

According to an example of the present application, counting, by a watch point counter, the watch point signals generated by the watch point generating unit.

According to an example of the present application, the current value of the watch point counter is latched into a counter register upon receiving the trigger signal thereat.

According to an example of the present application, current states of the one or more control signals is compared by an input comparator with states of the one or more control signals latched previously to detect whether the states of the one or more control signals have been changed. The previously latched states of the one or more control signals are latched at a previous watch point. In particular, the previously latched states of the one or more control signals are latched at the preceding watch point.

According to an example of the present application, each detection of unchanged states of the one or more control signals by the input comparator is counted by a constant counter.

According to an example of the present application, a fault signal is generated by a watchdog in case a next watch point signal is not generated by the watch dog generating unit within a predefined period of time.

In the foregoing specification, the invention has been described with reference to specific examples of embodiments of the invention. It will, however, be evident that various modifications and changes may be made therein without departing from the broader spirit and scope of the invention as set forth in the appended claims.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein can be designed as either negative or positive logic signals. Therefore, in alternate embodiments, those signals described as positive logic signals may be implemented as negative logic signals, and those signals described as negative logic signals may be implemented as positive logic signals.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented, which achieve the same functionality. For example, the multiple input signature register should be understood to represent one exemplary signature generating circuit. Those skilled in the art understand on the basis of the above description that any signature generating circuit may be applicable.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediary components. Likewise, any two components so associated can also be viewed as being “operably connected”, or “operably coupled”, to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

In one embodiment, the illustrated examples may be implemented as circuitry located on a single integrated circuit or within a same device. For example, the signal integrity module 300 may be implemented in the SoC 600. The signal integrity module 300 may comprise the signature comparator 330. Alternatively, the examples may be implemented as any number of separate integrated circuits or separate devices interconnected with each other in a suitable manner.

The examples, or portions thereof, may be implemented as soft or code representations of physical circuitry or of logical representations convertible into physical circuitry, such as in a hardware description language of any appropriate type.

It should be noted that invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as “computer systems”.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word “comprising” does not exclude the presence of other elements or steps then those listed in a claim. Furthermore, the terms “a” or “an”, as used herein, are defined as one or more than one. Also, the use of introductory phrases such as ‘at least one’ and ‘one or more’ in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an”. The same holds true for the use of definite articles. Unless stated otherwise, terms such as ‘first’ and ‘second’ are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. A signal integrity module for validating one or more control signals in time domain, comprising:
a signal input to receive the one or more control signals, wherein the one or more control signals are received from at least one control signal generating unit, wherein the one or more control signals are changing in time;
a watch point generating unit configured to generate watch point signals;
a signature generating unit operably coupled to the signal input to receive the one or more control signals and the watch point generating unit, wherein the signature generating unit is configured to generate a new signature on the basis of a current signature and the state of the one or more control signals at a watch point signalized by the watch point signal;
a signature register operably coupled to the signature generating unit and configured to latch the current signature upon receiving a trigger signal thereat, wherein the latched signature is representative of the time course of the one or more control signals at the watch point over a monitoring period defined by the trigger signal; and
a signature comparator operatively coupled to the signature register and configured to compare the latched signature with a pre-calculated signature to validate the integrity of the one or more control signals with respect to the time domain.

2. The signal integrity module according to claim 1, further comprising:
a watch point counter operatively coupled to the watch point generating unit and configured to count the watch point signals generated thereby.

3. The signal integrity module according to claim 2, further comprising:
a counter register operatively coupled to the watch point counter and configured to latch the current value of the watch point counter upon receiving the trigger signal thereat.

4. The signal integrity module according to claim 1, further comprising:
an input comparator operatively coupled to the signal input and configured to compare current states of the one or more control signals with states of the one or more control signals latched previously to detect whether the states of the one or more control signals have been changed.

5. The signal integrity module according to claim 4, further comprising:
a constant counter operatively coupled to the input comparator and configured to count each detection of unchanged states of the one or more control signals by the input comparator.

6. The signal integrity module according to claim 1, further comprising:
a watchdog operably coupled to the watch point generating unit and configured to generate a fault signal in case the watch point generating unit does not generate a next watch point signal within a predefined period of time.

7. The signal integrity module according to claim 1,
wherein the signature generating unit is configured to generate a real-time signature based on the current signature and the state of the one or more control signals at the watch point.

8. The signal integrity module according to claim 1,
wherein the one or more control signals are dual-value signals.

9. The signal integrity module according to claim 1,
wherein the watch point generating unit is configured to generate a clock signal to signalize the watch points.

10. The signal integrity module according to claim 9,
wherein the watch point generating unit is pre-scaler, which is configured to receive a clock signal and to scale the frequency of the received clock signal by a predefined factor, wherein the pre-scaler is configurable to allow adapting the predefined factor to a periodicity of the one or more control signals.

11. The signal integrity module according to claim 9,
wherein the watch point generating unit is clock signal generator, which is configured to generate the clock signal at a predefined frequency, wherein the clock signal generator is configurable to allow adapting the predefined frequency to a periodicity of the one or more control signals.

12. The signal integrity module according to claim 1,
wherein the signature generating unit is a multiple input signature register and the watch point signal is a shift signal, which is supplied to the multiple input signature register.

13. The signal integrity module according to claim 1,
wherein the one or more control signals are deterministic and periodic in time.

14. A method for validating the integrity of one or more control signals in time domain, comprising:
receiving the one or more control signals via a signal input from at least one control signal generating unit, wherein the one or more control signals are changing in time;
providing, by a watch point generating unit, watch point signals;
generating, by a signature generating unit, a new signature on the basis of a current signature and the state of the one or more control signals at a watch point signalized by the watch point signal;
latching the current signature into a signature register upon receiving a trigger signal thereat, wherein the latched signature is representative of the time course of the one or more control signals at the watch point over a monitoring period defined by the trigger signal; and
comparing, by a signature comparator, the latched signature with a pre-calculated signature to validate the integrity of the one or more control signals with respect to the time domain.

15. The method according to claim 14, further comprising:
counting, by a watch point counter, the watch point signals generated by the watch point generating unit.

16. The method according to claim 15, further comprising:
latching the current value of the watch point counter into a counter register upon receiving the trigger signal thereat.

17. The method according to claim 14, further comprising:
comparing, by an input comparator, current states of the one or more control signals with states of the one or more control signals latched previously to detect whether the states of the one or more control signals have been changed.

18. The method according to claim 17, further comprising:
counting, by a constant counter, each detection of unchanged states of the one or more control signals.

19. The method according to claim 14, further comprising:
generating, by a watchdog, a fault signal in case a next watch point signal is not generated by the watch dog generating unit within a predefined period of time.
